(19) United States
(12) Patent Application Publication
(10) Pub. No.: US 2006/0131334 A1
(43) Pub. Date: Jun. 22, 2006

(54) Stackable container for storing and dispensing liquid

(76) Inventor: Ronald S. Carlson, Motley, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/289,756

(22) Filed: Nov. 29, 2005

Related U.S. Application Data
(60) Provisional application No. 60/631,321, filed on Nov. 29, 2004.

(51) Int. Cl. B67D 5/60

(52) U.S. Cl. 222/143

(57) ABSTRACT

One embodiment of the invention described herein includes a stackable container. The stackable container includes a main body comprising a fill port that includes a fill portion and an offset portion wherein the fill portion and offset portion are offset from the main body to provide clearance for filling.

### CROSS-REFERENCE TO RELATED APPLICATIONS

The present application claims priority to U.S. Provisional Patent Application 60/631,321, filed on Nov. 29, 2004, which is incorporated herein by reference in its entirety.

### SUMMARY OF THE INVENTION

Described herein are embodiments of a device for storing and dispensing liquid, including storage of liquid in bulk.

One embodiment of the invention described herein includes a stackable container. The stackable container includes a main body comprising a fill port that includes a fill portion and an offset portion wherein the fill portion and offset portion are offset from the main body to provide clearance for filling.

### BACKGROUND OF THE INVENTION

Previously 55-gallon drums have been used to store bulk liquids and fluid materials. The drums are cylindrical members having generally flat top and bottom walls. An opening is located in the top of the drum. A pump mounted on the top is used to pump the fluid out of the drum. Leaks and spills create messy drum tops and drum storage areas. Also, transferring he pump from one drum to another drum allows dripping of fluid from the pump. The drums cannot be stacked on top of each other which takes up space.

### DESCRIPTION OF THE DRAWINGS

FIG. 1 is a perspective view of one embodiment of a liquid storage and dispensing unit that includes an offset filling mechanism.

FIG. 2 is a side view of one embodiment of the fill mechanism of the liquid storing and dispensing unit.

FIG. 3 is a perspective view of one embodiment of the fill mechanism of the liquid storing and dispensing unit.

FIG. 4 is a perspective view of one embodiment of liquid storage and dispensing units that are stacked.

FIG. 5 is a plan view of the top wall of a liquid storage and dispensing unit embodiment.

FIG. 6 is a plan view of the bottom wall of a liquid storage and dispensing unit embodiment.

### DESCRIPTION

In the following detailed description of the invention, reference is made to the accompanying drawings which form a part hereof, and in which are shown by way of illustration, specific embodiments in which the inventions may be practiced. These embodiments are described in sufficient detail to enable those skilled in the art to practice the present invention. Other embodiments may be utilized and structural, logical, and electrical changes may be made without departing from the scope of the invention. The various embodiments disclosed herein are not necessarily mutually exclusive, as some disclosed embodiments can be combined with one or more other disclosed embodiments to form new embodiments. The following detailed description is, therefore, not to be taken in a limiting sense, and the scope of the embodiments of the present invention is defined only by the appended claims, along with the full scope of equivalents to which such claims are entitled.

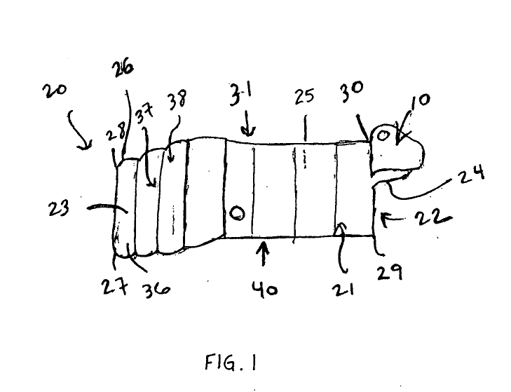

Referring to FIG. 1, a liquid storage and dispensing unit embodiment 20 includes a main body 22 having, for some embodiments, a cubic or rectangular shape. The main body 22 includes an upright front wall 21 joined to upright side walls 23 and 24, a back wall 26 and top and bottom walls 31 and 40. The main body 22 also includes a fill opening mechanism 10 that is offset from walls of the main body 22 for easier filling of the liquid storage unit 20. In particular, the fill opening mechanism enables easier filling of the liquid storage unit when it is stacked with other dispensing units.

The main body 22 encloses a chamber, which is not shown, for holding a liquid. The storage and dispensing unit embodiment 20 is a one-piece container made of plastic, such as polyethylene for some embodiments and other polymers for other embodiments. The storage and dispensing unit is made, for some embodiments, using a rotational molding process. The plastic is compatible with liquid stored in chamber 25. Square upright corners 27, 28, 29 and 30 are located at adjacent vertical portions of walls 21, 23, 24 and 26. While square upright corners are described, it is understood that rounded corners are suitable for some embodiments of the storage and dispensing unit 20.

Wall 23 includes a plurality of vertical ribs that extend from the top to the bottom of unit 20. It is understood that one or more of the walls includes the plurality of vertical ribs. Each rib 36, 37 and 38 has outwardly converging or tapered sides and a flat face joined to the sides. The ribs are corrugations that increase the strength of the walls and provide unit 20 with a distinctive appearance. The faces of the ribs are located in the planes of the outside walls of adjacent corners.

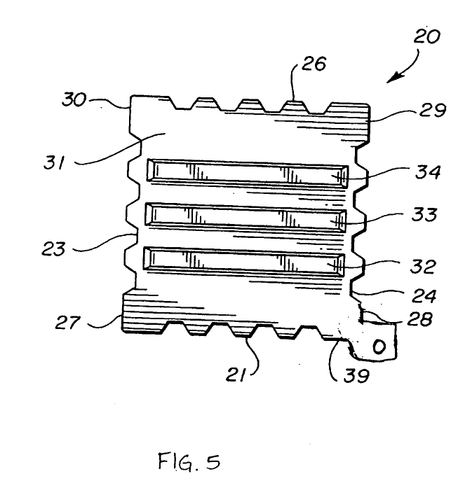

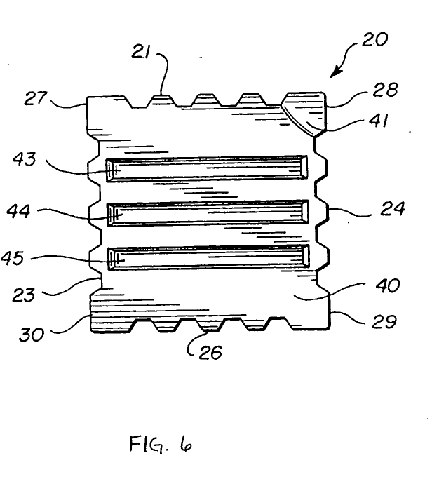

As shown in FIG. 5, in one embodiment, top wall 31 has three linear ribs 32, 33 and 34 that project upwardly from top wall 31. The opposite ends of each rib are located inwardly from side walls 23 and 24. In one embodiment, bottom wall 40, shown in FIG. 6, has three linear grooves 43, 44 and 45 that are complementary in shape and length to ribs 32, 33 and 34. Grooves 43, 44 and 45 are linear recesses of inwardly directed ribs in bottom wall 40. The ribs 32, 33 and 34 increase the strength of top wall 31 and provide keys which mate with grooves in another unit placed on top of unit 20. Other embodiments of the unit 20 include walls that are free of the ribs.

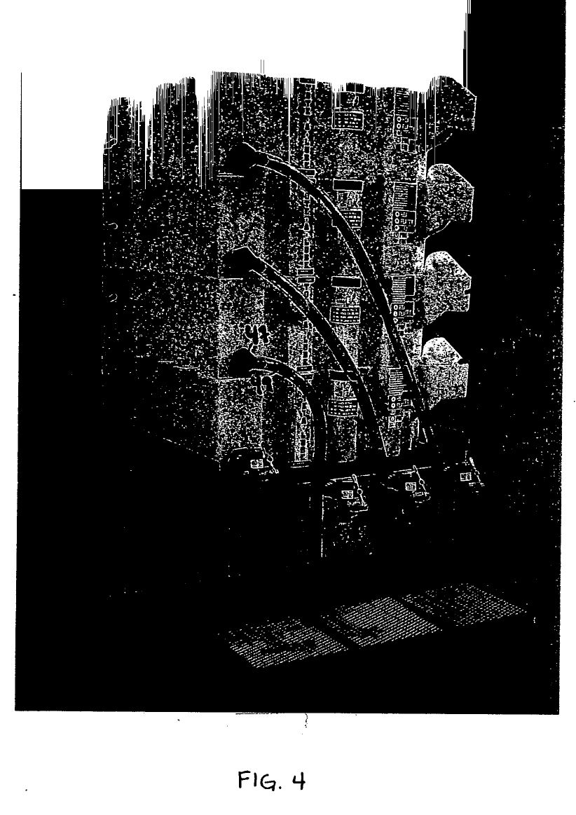

As shown in FIG. 4, several units 20A, 20B, 20C, and 20D are stackable in an aligned and fixed orientation. The mating ribs 32, 33, 34 and grooves 43, 44, 45 prevent relative lateral movement between the top and bottom units. A stand 46 having a square frame and downwardly directed legs supports the bottom unit 20A above a support surface or floor. A conventional ON-OFF drain valve 48 is secured to unit 20A in communication with opening 22. An ON-OFF drain valve 47 mounted on the bottom of the front wall of top unit 20B is used to control the flow of liquid from unit 20B into a hose 49. Hose 49 extends from valve 47 down adjacent unit 20A to platform 46. Another ON-OFF valve 51 attached to the lower end of hose 49 allows a person to fill a container with liquid with the container resting on the floor adjacent platform 46. Valves 47 and 48 can be connected with hoses to a pump used to dispense liquid to a remote location, such as a motor vehicle lube station. A conventional drain valve is shown in U.S. Pat. No. 5,259,509 and U.S. Pat. No. 6,135,324. Wall 21 has, for some embodiments, a recess of a size to accommodate the drain valve. The storing and dispensing units 20C and 20D include drain and fill mechanisms in accordance with what has been described for dispensing units 20A and 20B.

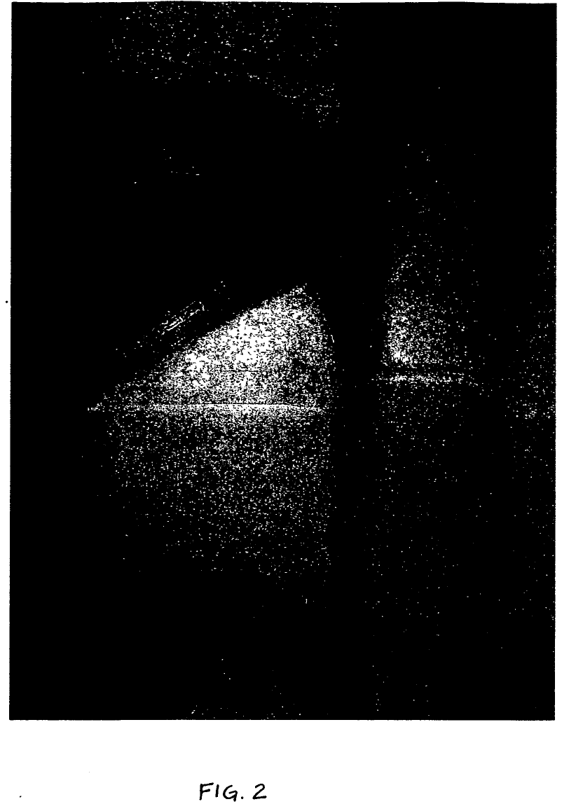

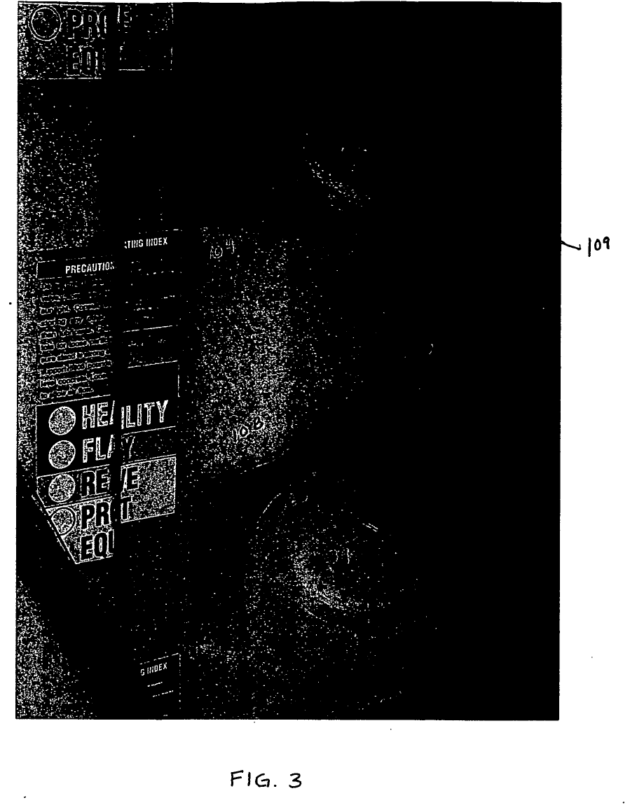

A corner portion 28 of each dispensing and fill units 20A, 20B, 20C and 20D includes a fill mechanism 10A, 10B, 10C and 10D, respectively. Each fill mechanism 10A, 101B, 10C and 10D defines an opening closed with a cap 39, illustrated in FIGS. 1, 2 and 3. When cap 39 is removed liquid is placed in chamber 25 via the opening in the fill mechanism 10.

The fill mechanism 10 includes a fill portion 102 and an offset portion 104 that attaches the fill portion 102 to the dispensing and fill unit 20. The fill portion 102 is sized to receive fluid without splashing and without overflowing. The fill portion 102 includes a top wall 120 that is slanted thereby rendering the fill opening more accessible than openings in a vertical top portion. The fill portion 102 includes two vertical walls 106 and 108 that meet to form a corner 109.

The offset portion 104 offsets the fill portion 102 so that it is easier to fill. The fill mechanism 10 of the storing and dispensing unit renders the unit easier to fill than units heretofore employed because the fill portion has more clearance for access. As shown in FIG. 4, when two units 20A and 20B are in stacked relation, clearance above and around the fill cap 39B is great enough so that the fill cap may be removed so that liquid can be placed in chamber 25 without altering the stack relationship of units 20A and 20B.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. It is to be understood that the above description is intended to be illustrative, and not restrictive, and that the phraseology or terminology employed herein is for the purpose of description and not of limitation. Combinations of the above embodiments, and other embodiments, will be apparent to those of skill in the art upon studying the above description. The scope of the present invention includes any other applications in which the above structures and fabrication methods are used. The scope of the present invention should be determined with reference to the appended claims, along with the full scope of equivalents to which such claims are entitled.

What is claimed is:

1. A stackable container, comprising:
a main body comprising a fill port that includes a fill portion and an offset portion wherein the fill portion and offset portion are offset from the main body to provide clearance for filling.

2. The stackable container of claim 1 wherein the fill portion of the fill port includes a pair of walls that terminate to form a corner.

3. The stackable container of claim 1 wherein the fill portion includes a top wall defining a fill opening.

4. The stackable container of claim 3 wherein the top wall is slanted.

5. The stackable container of claim 1 wherein the fill portion has a symmetry of a pie slice.

6. The stackable container of claim 1 wherein the offset portion offsets the fill port from the main body.

7. The stackable container of claim 1 wherein the main body has a rectangular or cubic shape.

8. The stackable container of claim 1 wherein the main body comprises ribs for stabilizing the container when the container is stacked.

9. The stackable container of claim 1 wherein the main body is plastic.
